(19) United States
(12) Patent Application Publication
(10) Pub. No.: US 2008/0182200 A1
(43) Pub. Date: Jul. 31, 2008

(54) Recording medium for electrophotographic image forming apparatus

(75) Inventor: Kil Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 12/003,210

(22) Filed: Dec. 20, 2007

(30) Foreign Application Priority Data
Jan. 25, 2007 (KR) 10-2007-0007904

(51) Int. Cl. G11B 7/24

(52) U.S. Cl. 430/270.14

(57) ABSTRACT

A recording medium for an electrophotographic image forming apparatus is provided, including: a substrate layer, a toner receiving layer formed on one side or both sides of the substrate layer, and an outermost layer formed on the toner receiving layer, in which the outermost layer includes a thermoplastic resin incorporating with a UV absorbing unit, and a composition for forming the outermost layer. The recording medium for an electrophotographic image forming apparatus has excellent light resistance and discoloration resistance, while maintaining good gloss.

### CROSS-REFERENCE TO RELATED PATENT APPLICATIONS

This application claims the benefit of Korean Patent Application No. 10-2007-0007904, filed on Jan. 25, 2007, in the Korean Intellectual Property Office, the disclosure of which is hereby incorporated by reference in its entirety.

### BACKGROUND OF THE INVENTION

1. Field of the Invention

The present invention relates to a recording medium, and more particularly, to a recording medium for an electrophotographic image forming apparatus. The recording medium includes a substrate layer, a toner receiving layer formed on one side or both sides of the substrate layer, and an outermost layer formed on the toner receiving layer, where the outermost layer includes a thermoplastic resin incorporated with a UV absorbing unit. The invention is also directed to a composition for forming the outermost layer.

2. Description of the Related Art

Data manipulation using a computer and printing the computed data using a printer are common processes in computing. Examples of such printers include dot impact printers, laser printers, thermal printers, inkjet printers, and the like. Printing processes using a laser beam (electrophotography) are generally used by consumers due to their high output rate and high resolution, together with inkjet printing processes. An electrophotographic process applied to a copier or printer typically consists of a five-step imaging process. The first step is to allow a photoconductor drum or belt to be charged in a dark room and the second step is to irradiate a laser beam to the photoconductor drum or belt, thereby producing a latent image. The third step is to expose the latent image to a charged toner, thereby fixing the toner by means of an electrostatic force. The fourth step is to allow a recording medium to pass between the photoconductor drum or belt and a corona, thereby transferring the toner to the recording medium. In this step, the recording medium should be somewhat conductive to transfer the toner image to the recording medium. The fifth and final step is to fix the transferred toner to the recording medium, which is achieved by hot fusing in which heat and pressure are mainly applied by a roller.

An image substrate material of the recording medium may be a general paper based on pulp raw material, a coated paper in which a mixture of a resin with a filler etc. is coated on a general paper, a white film in which a resin such as polyester is mixed with a filler, or the like. When a high glossy image equivalent to a silver salt photographic print is formed, as described in Japanese Patent Laid-open Publication Nos. 2000-010329, 2000-003060 and 2002-091212, it is preferable to use an image substrate material having a base comprised of a white film and a thermoplastic resin layer formed on the base. However, in these patents, although a UV absorbent can be added, since most UV absorbents are hydrophobic compounds, they have poor compatibility with aqueous compositions and a strength of coating is reduced.

### SUMMARY OF THE INVENTION

The present invention provides a recording medium for an electrophotographic image forming apparatus, which includes an outermost layer incorporated with a UV absorbing unit. The outermost layer provides excellent light resistance and discoloration resistance, while maintaining good gloss. The invention is also directed to a composition for forming the outermost layer on the recording medium.

According to an aspect of the present invention, a recording medium is provided for an electrophotographic image forming apparatus including a substrate layer, a toner receiving layer formed on one side or both sides of the substrate layer, and an outermost layer formed on the toner receiving layer, in which the outermost layer includes a thermoplastic resin having incorporated therein a UV absorbing component.

The thermoplastic resin incorporated with a UV absorbing component may include about 5 to 60 mol % of a repeating unit of a copolymerizable radical polymerizable monomer and about 40 to 95 mol % of a repeating unit of a UV absorbing monomer. The thermoplastic resin has a weight average molecular weight of about 500 to 50,000.

The UV absorbing monomer may be at least one selected from the group consisting of a benzophenone-based UV absorbing monomer represented by Formula 1, a benzotriazole-based UV absorbing monomer represented by Formula 2, and a formamidine-based UV absorbing monomer represented by Formula 3:

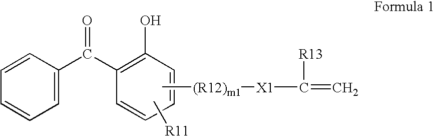

in which R11 is a hydrogen atom, a C₁-C₆ alkyl group, or a C₁-C₆ alkoxyl group,

R12 is a C₁-C₁₀ alkylene group or a C₁-C₁₀ oxyalkylene group,

m1 is 0 or 1,

R13 is a hydrogen atom, or a C₁-C₆ alkyl group, and

X1 is an ester group, an amide group, an ether group, or a urethane group,

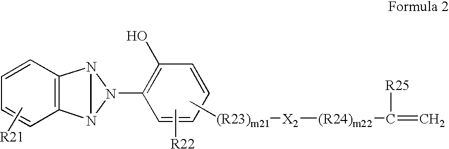

in which R21 is a hydrogen atom, a halogen atom, or a substituted or unsubstituted C₁-C₆ alkyl group,

R22 is a hydrogen atom, a substituted or unsubstituted C₁-C₆ alkyl group, or a substituted or unsubstituted C₁-C₆ alkoxyl group,

R23 is a C₁-C₁₀ alkylene group or a C₁-C₁₀ oxyalkylene group,

m21 is 0 or 1,

R24 is a C₁-C₈ alkylene group, a C₁-C₈ alkylene group having an amino group, or a C₁-C₈ alkylene group having a hydroxyl group,

m22 is 0 or 1,

R25 is a hydrogen atom or a C₁-C₆ alkyl group, and

X2 is an ester group, an amide group, an ether group, or a urethane group, and

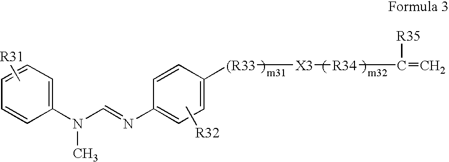

in which R31 is a hydrogen atom, a halogen atom, or a substituted or unsubstituted C₁-C₆ alkyl group,

R32 is a hydrogen atom, a substituted or unsubstituted C₁-C₆ alkyl group, or a substituted or unsubstituted C₁-C₆ alkoxyl group,

R33 is a substituted or unsubstituted C₁-C₁₀ alkylene group or a substituted or unsubstituted C₁-C₁₀ oxyalkylene group,

m31 is 0 or 1,

R34 is a C₁-C₈ alkylene group, a C₁-C₈ alkylene group having an amino group, or a C₁-C₈ alkylene group having a hydroxyl group,

m32 is 0 or 1,

R35 is a hydrogen atom, or a C₁-C₆ alkyl group, and

X3 is an ester group, an amide group, an ether group, or a urethane group.

The polymerizable monomer may be at least one selected from the group consisting of an unsaturated aromatic compound, an alkyl ester of α,β-unsaturated monocarboxylic acid, an amide group-containing monomer, and an unsaturated carboxylic acid.

The thermoplastic resin may be in the form of particles having a multi-layered structure having a core part and a shell part.

The amount of the thermoplastic resin may be about 75 to 95 parts by weight based on 100 parts by weight of total solids of the outermost layer of the recording medium.

The outermost layer of the recording medium may further include a binder.

The binder of the outermost receiving layer may be at least one selected from the group consisting of polyvinyl alcohol, polyvinyl pyrrolidone, methyl cellulose, hydroxy propylmethyl cellulose, gelatin, polyethylene oxide, acrylic polymer, polyester, polyurethane, epoxy resin, latex, and quaternary ammonium-based copolymer.

The outermost layer of the recording medium may further include additives.

The outermost layer of the recording medium may have a thickness of about 5 to 15 μm.

The substrate layer of the recording medium may be a single layer or a laminate of two or more layers selected from the group consisting of a synthetic paper, a uncoated paper, an art paper, a coated paper, a mixed drafting paper, baryta, an incorporated paper, cardboard, a cellulose fiber paper, a transparent or translucent plastic film selected from polyolefin, polyvinyl chloride, polyethylene terephthalate, polystyrene, polymethacrylate or polycarbonate, and a foam sheet.

The substrate layer of the recording medium may have a thickness of about 25 to 260 μm.

The toner receiving layer of the recording medium may further include a filler and a binder.

The filler may be an inorganic filler selected from the group consisting of kaolin clay, silica, calcium carbonate, talc, aluminum hydroxide, satin white, titanium dioxide, calcined clay, zinc oxide, and barium sulfate, or an organic filler selected from the group consisting of styrene-based resin, acrylic resin, vinyl chloride, and polycarbonate.

The binder of the toner receiving layer may be at least one selected from the group consisting of polyvinyl alcohol, polyvinyl pyrrolidone, methyl cellulose, hydroxy propylmethyl cellulose, gelatin, polyethylene oxide, acrylic polymer, polyester, polyurethane, epoxy resin, latex, and quaternary ammonium-based copolymer.

The toner receiving layer may have a thickness of about 1 to 20 μm.

The toner receiving layer may further include additives.

According to another aspect of the present invention, a composition is provided for forming an outermost layer of a recording medium for an electrophotographic image forming apparatus including: a thermoplastic resin having a UV absorbing group incorporated therein which contains about 5 to 60 mol % of a repeating unit of a copolymerizable radical polymerizable monomer and about 40 to 95 mol % of a repeating unit of a UV absorbing monomer wherein the thermoplastic resin has a weight average molecular weight of about 500 to 50,000; and a solvent.

The UV absorbing monomer may be at least one selected from the group consisting of a benzophenone-based UV absorbing monomer represented by Formula 1, a benzotriazole-based UV absorbing monomer represented by Formula 2, and a formamidine-based UV absorbing monomer represented by Formula 3:

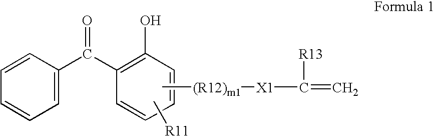

in which R11 is a hydrogen atom, a substituted or unsubstituted C₁-C₆ alkyl group, or a substituted or unsubstituted C₁-C₆ alkoxyl group,

R12 is a substituted or unsubstituted C₁-C₁₀ alkylene group or a substituted or unsubstituted C₁-C₁₀ oxyalkylene group,

m1 is0 or 1,

R13 is a hydrogen atom or a substituted or unsubstituted C₁-C₆ alkyl group, and

X1 is an ester group, an amide group, an ether group, or a urethane group,

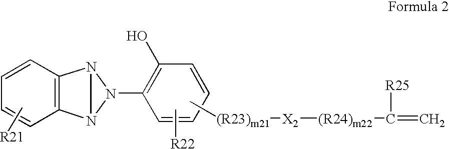

in which R21 is a hydrogen atom, a halogen atom, or a substituted or unsubstituted C₁-C₆ alkyl group,

R22 is a hydrogen atom, a substituted or unsubstituted C₁-C₆ alkyl group, or a substituted or unsubstituted C₁-C₆ alkoxyl group,

R23 is a substituted or unsubstituted C₁-C₁₀ alkylene group or a substituted or unsubstituted C₁-C₁₀ oxyalkylene group,

m21 is0 or 1,

R24 is a substituted or unsubstituted C₁-C₈ alkylene group,

m22 is 0 or 1,

R25 is a hydrogen atom or a substituted or unsubstituted C₁-C₆ alkyl group, and

X2 is an ester group, an amide group, an ether group, or a urethane group, and

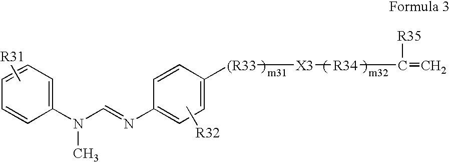

in which R31 is a hydrogen atom, a halogen atom, or a substituted or unsubstituted C₁-C₆ alkyl group,

R32 is a hydrogen atom, a substituted or unsubstituted C₁-C₆ alkyl group, or a substituted or unsubstituted C₁-C₆ alkoxyl group,

R33 is a substituted or unsubstituted C₁-C₁₀ alkylene group or a substituted or unsubstituted C₁-C₁₀ oxyalkylene group,

m31 is 0 or 1,

R34 is a substituted or unsubstituted C₁-C₈ alkylene group,

m32 is 0 or 1,

R35 is a hydrogen atom or a substituted or unsubstituted C₁-C₆ alkyl group, and

X3 is an ester group, an amide group, an ether group, or a urethane group.

The polymerizable monomer may be at least one selected from the group consisting of an unsaturated aromatic compound, an alkyl ester of α,β-unsaturated monocarboxylic acid, an amide group-containing monomer, and an unsaturated carboxylic acid.

These and other aspects of the invention will become apparent from the following detailed description of the invention and the drawing which disclose various embodiments of the invention.

### BRIEF DESCRIPTION OF THE DRAWINGS

The above and other features and advantages of the present invention will become more apparent by describing in detail exemplary embodiments thereof with reference to the attached drawing in which:

FIG. 1 is a cross-sectional view of a recording medium for an electrophotographic image forming apparatus, according to an embodiment of the present invention.

### DETAILED DESCRIPTION OF THE INVENTION

UV absorbents are typically used in recording mediums for electrophotographic image forming apparatuses to block UV light which can degrade polymers or remove the activity of base molecules excited by light, and to convert the absorbed energy to heat. However, UV absorbents used alone have the following problems. Most UV absorbents are hydrophobic compounds, and thus have poor compatibility with aqueous compositions. Thus, the prior UV absorbents should be used in a small amount. The amount that can be added is further reduced due to bleed-out. In addition, such poor compatibility with aqueous compositions reduces smoothness and transparency of coated layers that include the UV absorbents, and reduce the strength of coating.

However, according to an embodiment of the present invention, by incorporating a reactive UV absorbing component or group with a thermoplastic resin, the dispersion of a UV absorbent in an aqueous composition can be improved and the problems such as bleed-out can be prevented. That is, a single compound can be used to obtain both good gloss and improvement of light resistance and discoloration resistance.

According to an embodiment of the present invention, a thermoplastic resin having a UV absorbing group can be used to provide a recording medium having improved light resistance and discoloration resistance while maintaining good gloss.

The recording medium according to the current embodiment of the present invention includes a substrate layer, a toner receiving layer formed on the substrate layer, and an outermost layer formed on the toner receiving layer. Further, if required, each of the toner receiving layer and the outermost layer may be formed on one side or both sides of the substrate layer.

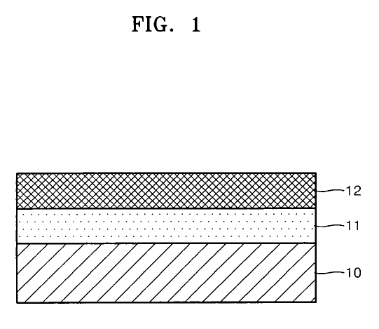

FIG. 1 is a cross-sectional view of a recording medium for an electrophotographic image forming apparatus, according to an embodiment of the present invention. Referring to FIG. 1, the recording medium includes a substrate layer 10, a toner receiving layer 11 formed on the substrate layer 10, and an outermost layer 12 formed on the toner receiving layer 11.

The substrate layer 10 may be any substrate used in a conventional recording medium and is not particularly restricted. That is, the substrate layer 10 may be appropriately selected provided that it can withstand the fixing temperature and can provide the desired smoothness, whiteness, friction, antistatic and fixing properties. Specific examples of such substrates include paper substrates such as synthetic papers (e.g., synthetic papers based on polyolefin or polystyrene), uncoated papers, art papers, coated papers, mixed drafting papers produced from a synthetic resin pulp such as polyethylene and a natural pulp, baryta, synthetic resin or emulsion-incorporated papers, synthetic rubber latex-incorporated papers, cardboard, cellulose fiber papers, and the like and plastic film substrates such as polyolefin, polyvinyl chloride, polyethylene terephthalate, polystyrene, polymethacrylate, polycarbonate, and the like. In addition, a white opaque film prepared by adding fillers to such synthetic resins, or a foam sheet, etc. may be used. These substrates may be used alone or as a laminate of two or more layers, for example, as a laminate of a cellulose fiber paper and a synthetic paper or as a laminate of a cellulose fiber paper and a plastic film.

It is preferable that the substrate layer 10 have a high surface smoothness. The surface roughness (smoothness) is preferably about 210 sec or more, more preferably about 250 sec or more, when measured using the Bekk method (KSM7028). When the smoothness is less than 210 sec, image quality of images produced on the recording medium may be poor. The thickness of the substrate layer 10 may be established according to the desired purpose of the recording medium and is preferably about 25 to 260 μm, and more preferably about 75 to 220 μm. When adhesion between the substrate layer 10 and the toner receiving layer 11 formed thereon, to be described below, is poor, the surface of the substrate layer 10 on which the toner receiving layer 11 is formed may be subjected to a primer treatment or a corona discharge treatment.

The toner receiving layer 11 may include any component used in a conventional recording medium. Fillers and a binder may be used as main components of the toner receiving layer 11. The filler may be an inorganic filler, an organic filler, or a combination thereof.

Particles of the inorganic filler have preferably an average particle diameter of about 2.5 μm or less, more preferably about 2.0 to 0.1 μm. Examples of inorganic fillers include kaolin clay, silica, calcium carbonate, talc, aluminum hydroxide, satin white, titanium dioxide, calcined clay, zinc oxide, and barium sulfate. Examples of organic fillers include styrene-based resins such as polystyrene and polymethyl styrene; acrylic resins such as polymethyl methacrylate and polyacrylonitrile; vinyl chloride; and polycarbonate. These fillers may be used in combination with other materials such as the binder. The combination ratio of the filler and the binder is typically about 95:5 to 10:90, preferably about 95:5 to 40:60, more preferably about 95:5 to 60:40 by weight. When the combination ratio of the filler and the binder is less than 95:5 by weight, adhesion of the toner receiving layer 11 to the substrate layer 10 is reduced. When the combination ratio of the filler and the binder is greater than 10:90 by weight, most fillers are embedded in the binder, and thus do not function to provide an increased benefit.

The binder may be at least one selected from the group consisting of polyvinyl alcohol, polyvinyl pyrrolidone, methyl cellulose, hydroxy propylmethyl cellulose, gelatin, polyethylene oxide, acrylic polymer, polyester, polyurethane, epoxy resin, latex, and quaternary ammonium-based copolymer.

The latex may be a styrene-butadiene latex, a styrene-butadiene-acrylonitrile latex, or an acrylic latex.

The amount of the combination of the filler and the binder is about 50 to 99 parts by weight, preferably about 60 to 95 parts by weight, based on 100 parts by weight of total solids of the toner receiving layer 11. When the amount of the combination of the filler and the binder is less than 50 parts by weight based on 100 parts by weight of total solids of the toner receiving layer 11, it is difficult to fix a toner to a recording medium and adhesion of the toner receiving layer 11 to the substrate layer 10 is poor. When the amount of the combination of the filler and the binder is greater than 99 parts by weight based on 100 parts by weight of total solids of the toner receiving layer 11, the properties of a coated surface are poor and cracks are produced.

The toner receiving layer 11 may further include a variety of additives for improving a printed image or stability of the toner receiving layer 11 and for improving processibility during processing the recording medium to compensate physical properties thereof. Examples of such additives include an antistatic agent, a crosslinking agent, a dye, an optical brightener, a pH controlling agent, an antioxidant, an antifoaming or defoaming agent, a leveling agent, a lubricant, an anti-coloring agent, a surface controlling agent, a thickener, a UV absorbent, an anti-degrading agent, an anti-ozone degrading agent, a preservative, and the like.

In particular, an electrophotographic printing process is performed by charging a toner and then transferring the charged toner to a printing paper. Thus, the electroconductivity of the printing paper greatly affects the accuracy of formed images. (Since the electroconductivity is conversely represented by a surface resistance of a coating layer, the term “surface resistance” is also used herein.) Electroconductive polymers may be used as components of the substrate layer 10 and the toner receiving layer 11 and additives, for example, an antistatic agent, and the like may be added to ensure electroconductivity. Examples of antistatic agents include inorganic salts such as sodium chloride and potassium chloride, or polyhydric alcohols such as glycerin, propylene glycol, ethylene glycol, polyethylene glycol, trimethylene glycol and sorbitol, and quaternary ammonium salts. These materials are mainly referred to as antistatic agents rather than as agents for providing electroconductivity since they have an antistatic function and simultaneously prevent continuous feed of paper due to the occurrence of static electricity.

Whether the toner receiving layer 11 includes the electroconductive polymer alone or the antistatic agent is added, the surface resistance of the toner receiving layer 11 may be maintained at 10⁹ to 10¹⁴Ω (measured at 20° C. and relative humidity 20%) to achieve fixing of toner and to prevent scattering of toner. In a conventional recording medium, inorganic salts such as sodium chloride and potassium chloride or quaternary ammonium salts are used to control the surface resistance of the recording medium. However, it is difficult to control the surface resistance of the recording medium within a fixed range under conditions of varying temperature and humidity using these components. For example, the surface resistance may be reduced to cause transfer failure at a relatively high temperature of 32° C. and a relatively high humidity of 90% RH. The surface resistance of the toner receiving layer is measured according to standard methods as known in the art.

The total amount of additives in the toner receiving layer 11 may be about 1 to 5 parts by weight based on 100 parts by weight of total solids of the toner receiving layer 11. When the amount of additives is less than 1 part by weight based on 100 parts by weight of total solids of the toner receiving layer 11, the effects of adding additives are insignificant. When the amount of additives is greater than 5 parts by weight based on 100 parts by weight of total solids of the toner receiving layer 11, the smoothness of a coated layer and a strength of coating are reduced.

The thickness of the toner receiving layer 11 may be about 1 μm to about 20 μm, preferably about 5 to 10 μm. When the thickness of the toner receiving layer 11 is less than 1 μm, it does not function as a toner receiving layer. When the thickness of the toner receiving layer 11 is greater than 20 μm, the material costs increase and it is difficult to dry the coating.

The outermost layer 12 includes a thermoplastic resin having incorporated therein a UV absorbing group. The UV absorbing group is formed from a polymerizable UV absorbing monomer that is copolymerized with a monomer for forming the thermoplastic resin.

The thermoplastic resin with the UV absorbing group may include about 5 to 60 mol % of a repeating unit of a copolymerizable radical polymerizable monomer and about 40 to 95 mol % of a repeating unit of a UV absorbing monomer. In one embodiment, the thermoplastic resin has a weight average molecular weight of about 500 to 50,000.

The thermoplastic resin with a UV absorbing group allows a UV absorbent to be reactive, thereby easily preparing polymer types of UV absorbent. Thus, drawbacks of the addition type of UV absorbent can be avoided. Since the concentration of UV absorbent can be selected in the thermoplastic resin, and the resulting thermoplastic resin has properties of a reactive UV absorbent, the thermoplastic resin incorporating the UV absorbing group can improve light resistance and discoloration resistance.

The UV absorbing monomer may be at least one selected from the group consisting of a benzophenone-based UV absorbing monomer represented by Formula 1, a benzotriazole-based UV absorbing monomer represented by Formula 2, and a formamidine-based UV absorbing monomer represented by Formula 3:

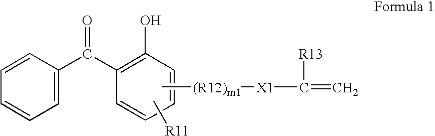

in which R11 is a hydrogen atom, a substituted or unsubstituted C₁-C₆ alkyl group, or a substituted or unsubstituted C₁-C₆ alkoxyl group,

R12 is a substituted or unsubstituted C₁-C₁₀ alkylene group or a substituted or unsubstituted C₁-C₁₀ oxyalkylene group,

m1 is 0 or 1,

R13 is a hydrogen atom, or a substituted or unsubstituted C₁-C₆ alkyl group, and

X1 is an ester group, an amide group, an ether group, or a urethane group,

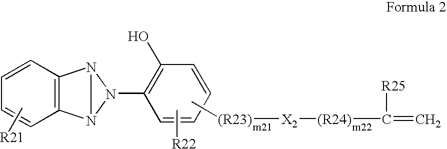

in which R21 is a hydrogen atom, a halogen atom, or a substituted or unsubstituted C₁-C₆ alkyl group,

R22 is a hydrogen atom, a substituted or unsubstituted C₁-C₆ alkyl group, or a substituted or unsubstituted C₁-C₆ alkoxyl group,

R23 is a substituted or unsubstituted C₁-C₁₀ alkylene group or a substituted or unsubstituted C₁-C₁₀ oxyalkylene group,

m21 is 0 or 1,

R24 is a substituted or unsubstituted C₁-C₈ alkylene group,

m22 is0 or 1,

R25 is a hydrogen atom, or a substituted or unsubstituted C₁-C₆ alkyl group, and

X2 is an ester group, an amide group, an ether group, or a urethane group, and

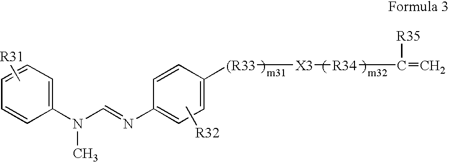

in which R31 is a hydrogen atom, a halogen atom, or a C₁-C₆ alkyl group,

R32 is a hydrogen atom, a substituted or unsubstituted C₁-C₆ alkyl group, or a substituted or unsubstituted C₁-C₆ alkoxyl group,

R33 is a substituted or unsubstituted C₁-C₁₀ alkylene group or a substituted or unsubstituted C₁-C₁₀ oxyalkylene group,

m31 is 0 or 1,

R34 is a substituted or unsubstituted C₁-C₈ alkylene group,

m32 is 0 or 1,

R35 is a hydrogen atom, or a substituted or unsubstituted C₁-C₆ alkyl group, and

X3 is an ester group, an amide group, an ether group, or a urethane group.

As used herein, the C₁-C₆ alkyl group refers to a linear or branched hydrocarbon chain radical which is composed of only carbon atoms and hydrogen atoms, is not unsaturated, has 1 to 6 carbon atoms, and has atoms bonded to other atoms of a molecule by a single bond. Examples of such a C₁-C₆ alkyl group include methyl, ethyl, propyl, isobutyl, sec-butyl, tert-butyl, pentyl, iso-amyl and hexyl groups. A C₁-C₄ alkyl group is particularly preferable. At least one hydrogen atom in the alkyl group may be substituted by a hydroxy group, a nitro group, a cyano group, a substituted or unsubstituted amino group (—NH₂, —NH(R), —N(R′)(R″), in which R′ and R″ are each independently a C₁-C₁₀ alkyl group), an amido group, a hydrazine or hydrazone group, a carboxyl group, sulfonic group, a phosphoric group, a C₁-C₆ alkyl group, a halogenated C₁-C₆ alkyl group, a C₁-C₆ alkenyl group, a C₁-C₆ alkynyl group, a C₁-C₆ heteroalkyl group, a C₁-C₆ aryl group, a C₁-C₆ arylalkyl group, a C₁-C₆ heteroaryl group, or a C₁-C₆ heteroarylalkyl group.

As used herein, the C₁-C₆ alkoxy group refers to an alkyl group having oxygen at its end, i.e., a group having a structure of ‘alkyl-O—’. Examples of such a C₁-C₆ alkoxy group include methoxy, ethoxy, propyloxy, isobutyloxy, sec-butyloxy, tert-butyloxy, pentyloxy, iso-amyloxy, hexyloxy groups, and the like. A C₁-C₄ alkoxyl group is preferable. At least one hydrogen atom in the alkoxyl group may be substituted by the same substituents for the alkyl group as described above.

As used herein, the C₁-C₁₀ alkylene group refers to a linear or branched divalent hydrocarbon chain which has atoms of a molecule bonded to a radical group, is composed of only carbon atoms and hydrogen atoms, is not unsaturated, and has 1 to 10 carbon atoms. Examples of such a C₁-C₁₀ alkylene group include methylene, ethylene, propylene, isobutylene, sec-butylene, tert-butylene, pentylene, iso-amylene, hexylene, heptylene, octylene, nonylene and decylene groups. A C₁-C₄ alkylene group is particularly preferable. At least one hydrogen atom in the alkylene group may be substituted by the same substituents for the alkyl group as described above.

As used herein, the C₁-C₁₀ oxyalkylene group refers to an alkylene group having oxygen at its end, i.e., a divalent chain having a structure of ‘—O-alkylene-’. Examples of such a C₁-C₁₀ oxyalkylene group include oxymethylene, oxyethylene, oxypropylene, oxyisobutylene, oxy-sec-butylene, oxy-tert-butylene, oxypentylene, oxy-iso-amylene, oxyhexylene, oxyheptylene, oxyoctylene, oxynonylene and oxydecylene groups. A C₁-C₄ oxyalkylene group is particularly preferable. At least one hydrogen atom in the oxyalkylene group may be substituted by the same substituents for the alkyl group as described above.

The polymerizable monomer (A) may be any radical polymerizable monomer which can be copolymerized with the UV absorbing monomer. Non-limiting examples of such a polymerizable monomer include an unsaturated aromatic compound, an alkyl ester of α,β-unsaturated monocarboxylic acid, an amide group-containing monomer, and an unsaturated carboxylic acid, and a hydroxyl group-containing monomer.

Examples of the unsaturated aromatic compound include styrene, α-methyl styrene, and vinyl toluene.

Examples of the alkyl ester of α,β-unsaturated monocarboxylic acid include alkyl esters of acrylic or methacrylic acid. Examples of the alkyl esters of acrylic or methacrylic acid include methyl acrylate, ethyl acrylate, propyl acrylate, isopropyl acrylate, butyl acrylate, isobutyl acrylate, hexyl acrylate, cyclohexyl acrylate, 2-ethylhexyl acrylate, lauryl acrylate, methyl methacrylate, ethyl methacrylate, propyl methacrylate, isopropyl acrylate, butyl methacrylate, isobutyl methacrylate, hexyl methacrylate, cyclohexyl methacrylate, 2-ethylhexyl methacrylate, and lauryl methacrylate.

Examples of the amide group-containing monomer include acrylamide, methacryl amide, N,N-methylene bis acrylamide, diacetone acrylamide, maleic amide, and maleimide.

Examples of the unsaturated carboxylic acid include acrylic acid, methacrylic acid, maleic acid, fumaric acid, itaconic acid, and monoalkylitaconate.

Examples of the hydroxyl group-containing monomer include 2-hydroxy ethyl acrylate, 2-hydroxy ethyl methacrylate, hydroxyl propyl acrylate, hydroxyl propyl methacrylate, and polyethylene glycol acrylate.

These radical polymerizable monomers may be used in a combination.

The thermoplastic resin may be a multi-layered structure having a core part and a shell part. For example, the thermoplastic resin may be a latex, in which a shell part includes a copolymer (a) and a core part includes a copolymer (b). Examples of the copolymer (a) included in the shell part include an unsaturated aromatic compound, an alkyl ester of α,β-unsaturated monocarboxylic acid, a hydroxyl group-containing monomer, and an amide group-containing monomer as described above. The copolymer (a) included in the shell part is preferably an amide group-containing monomer, and more preferably, methacrylamide.

Examples of a nonionic radical polymerizable monomer of the copolymer (b) included in the core part include an unsaturated aromatic compound, an alkyl ester of α,β-unsaturated monocarboxylic acid, a hydroxyl group-containing monomer, and an amide group-containing monomer as described above. The nonionic radical polymerizable monomer may be an alkyl ester of α,β-unsaturated monocarboxylic acid or a hydroxyl group-containing monomer.

The copolymer (b) included in the core part may further include a crosslinkable radical polymerizable monomer in addition to the nonionic radical polymerizable monomer. The crosslinkable radical polymerizable monomer refers to a radical polymerizable monomer having two or more radical polymerizable double bonds or having a functional group which provides a self-crosslinking structure during and after polymerization. Examples of the radical polymerizable monomer having two or more radical polymerizable double bonds include divinyl benzene, polyoxyethylene diacrylate, polyoxyethylene dimethacrylate, polyoxy propylene diacrylate, polyoxy propylene diacrylate, polyoxy propylene dimethacrylate, neopentyl glycol diacrylate, neopentyl glycol dimethacrylate, butanediol diacrylate, butanediol dimethacrylate, trimethylol propane triacrylate, trimethylol propane trimethacrylate, pentaerythritol tetraacrylate, and pentaerythritol tetramethacrylate.

The amount of the repeating unit of the copolymerizable radical polymerizable monomer may be about 5 to 60 mol % and the amount of the repeating unit of the UV absorbing monomer may be about 40 to 95 mol %. When the amount of the repeating unit of the copolymerizable radical polymerizable monomer is less than 5 mol %, dispersibility in an aqueous composition is poor and gloss is reduced. When the amount of the repeating unit of the copolymerizable radical polymerizable monomer is greater than 60 mol %, the UV absorbing effect is reduced.

The weight average molecular weight of the thermoplastic resin is about 500 to 50,000, preferably about 700 to 10,000, and more preferably about 1,000 to 5,000. When the molecular weight of the thermoplastic resin is less than 500, it does not function as an outermost layer. When the molecular weight of the thermoplastic resin is greater than 50,000, it is difficult to form the outermost layer.

The amount of the thermoplastic resin may be about 75 to 95 parts by weight, preferably about 80 to 90 parts by weight, based on 100 parts by weight of total solids of the outermost layer 12. When the amount of the thermoplastic resin is less than 75 parts by weight based on 100 parts by weight of total solids of the outermost layer 12, gloss is reduced and the UV absorbing effect is not obtained. When the amount of the thermoplastic resin is greater than 95 parts by weight based on 100 parts by weight of total solids of the outermost layer 12, the viscosity of a coating solution increases.

The outermost layer 12 may further include a binder in addition to the thermoplastic resin incorporating the UV absorbing group. The binder may be at least one selected from the group consisting of polyvinyl alcohol, polyvinyl pyrrolidone, methyl cellulose, hydroxy propylmethyl cellulose, gelatin, polyethylene oxide, acrylic polymer, polyester, polyurethane, epoxy resin, latex, and quaternary ammonium-based copolymer.

The latex may be a styrene-butadiene latex, a styrene-butadiene-acrylonitrile latex, or an acrylic latex.

The amount of the binder in the outermost layer 12 is about 1 part by weight to about 15 parts by weight, preferably 2 to 10 parts by weight, based on 100 parts by weight of total solids of the outermost layer 12. When the amount of the binder is less than 1 part by weight based on 100 parts by weight of total solids of the outermost layer 12, gloss is reduced and the UV absorbing effect is not obtained. When the amount of the binder is greater than 15 parts by weight based on 100 parts by weight of total solids of the outermost layer 12, the viscosity of a coating solution increases.

Similar to the toner receiving layer 11, the outermost layer 12 may further include various additives for improving a printed image or stability of the outermost layer 12 and for improving processibility during processing of the recording medium to compensate physical properties thereof. Examples of such additives include an antistatic agent, a crosslinking agent, a dye, an optical brightener, a light diffusing agent, a pH controlling agent, an antioxidant, an antifoaming or defoaming agent, a leveling agent, a lubricant, an anti-coloring agent, a surface controlling agent, a thickener, a UV absorbent, an anti-degrading agent, an anti-ozone degrading agent, a preservative, and the like.

The total amount of additives in the outermost layer 12 may be about 1 part by weight to about 15 parts by weight, preferably about 2 to 10 parts by weight, based on 100 parts by weight of total solids of the outermost layer 12. When the amount of the additives is less than 1 part by weight based on 100 parts by weight of total solids of the outermost layer 12, the effects of adding additives are insignificant. When the amount of the additives is greater than 15 parts by weight based on 100 parts by weight of total solids of the outermost layer 12, the smoothness and transparency of a coated layer and a strength of coating are reduced.

The outermost layer 12 may have a thickness of about 5 to 15 μm, preferably about 5 to 10 μm. When the thickness of the outermost layer 12 is less than 5 μm, the effect of the outermost layer 12 is insignificant. When the thickness of the outermost layer is greater than 15 μm, the processibility of the recording medium is deteriorated and production costs increase.

In the current embodiment of the present invention, the toner receiving layer 11 and the outermost layer 12 are formed by coating compositions for forming the toner receiving layer 11 and the outermost layer 12 on the substrate layer 10 and drying the compositions.

The compositions for forming the toner receiving layer 11 and the outermost layer 12 may further include a solvent in addition to solid components included in the toner receiving layer 11 and the outermost layer 12 as described above.

The solvent is not particularly limited, but water is primarily used as the solvent in consideration of environmental problems and workability.

Alternatively, the solvent may be selected from the group consisting of ketones, glycol ethers, alcohols, methyl cellosolve, ethyl cellosolve, dimethyl formamide, and dimethyl sulfoxide. Examples of ketones include acetone and methyl ethyl ketone. Examples of glycol ethers include diethylene glycol and diethylene glycol monobutyl ether. Examples of alcohols include methanol, ethanol, butanol, and isopropanol.

The solvent may be present in an amount such that the amount of solids of compositions for forming the toner receiving layer 11 and the outermost layer 12 are about 5 to 60% by weight based on 100% by weight of total components of compositions for forming the toner receiving layer 11 and the outermost layer 12. When the amount of solids of compositions for forming the toner receiving layer 11 and the outermost layer 12 is less than 5% by weight based on 100% by weight of total components of compositions for forming the toner receiving layer 11 and the outermost layer 12, drying of a coating is difficult. When the amount of solids of compositions for forming the toner receiving layer 11 and the outermost layer 12 is greater than 60% by weight based on 100% by weight of total components of compositions for forming the toner receiving layer 11 and the outermost layer 12, viscosity of coating solutions increases, which results in cracks and undesired defects.

The recording medium for the electrophotographic image forming apparatus according to the current embodiment of the present invention is prepared by sequentially coating compositions for forming the toner receiving layer 11 and the outermost layer 12 on one side or both sides the substrate layer 10 and drying them to form the toner receiving layer 11 and the outermost layer 12.

The drying of the compositions for forming the toner receiving layer 11 and the outermost layer 12 may be performed in a temperature range of about 50 to 130° C. When a crosslinking agent is added in this process, thermal crosslinking is performed by the crosslinking agent. When the drying temperature is lower than 50° C., the crosslinking property is reduced. When the drying temperature is higher than 130° C., yellowing occurs.

The present invention will now be described in greater detail with reference to the following examples. The following examples are for illustrative purposes only and are not intended to limit the scope of the invention.

### PREPARATION EXAMPLES

### Preparation Example 1

430 parts of distilled water and 30 parts of 2-[2′-hydroxy-5′-(methacryloyl oxy)phenyl]benzotriazole were put into a frasco equipped with a stirrer, and heated to 80° C. 40 parts of a 5% aqueous solution of 2,2′-azobis(2-amidino propane)dihydrochloride was added, and then the mixture was left for 5 minutes. Subsequently, an aqueous solution portion containing 48 parts of a 5% aqueous solution of 2,2′-azobis(2-amidino propane)dihydrochloride and 186 parts of distilled water and a monomer portion containing 120 parts of dimethylamino propyl acrylamide methyl chloride, 200 parts of methyl methacrylate, 320 parts of butyl acrylate, and 160 parts of styrene were respectively added over 90 minutes. Then stirring was continued for 60 minutes.

Thereafter, the resultant was cooled to 30° C. or lower, and filtered using an 80 mesh screen. Then water was added until the amount of solids was 40% by weight.

### Preparation Example 2

590 parts of distilled water and 240 parts of 2-hydroxy-4-acryloyl oxy benzophenone were put into a frasco equipped with a stirrer, and heated to 80° C. 40 parts of a 5% aqueous solution of 2,2′-azobis(2-amidino propane)dihydrochloride was added, and then the mixture was left for 5 minutes. Subsequently, an aqueous solution portion containing 48 parts of a 5% aqueous solution of 2,2′-azobis(2-amidino propane)dihydrochloride and 186 parts of distilled water and a monomer portion containing 120 parts of dimethylamino propyl acrylamide methyl chloride, 200 parts of methyl methacrylate, 320 parts of butyl acrylate, and 160 parts of styrene were respectively added over 90 minutes. Then stirring was continued for 60 minutes.

Thereafter, the resultant was cooled to 30° C. or lower, and filtered using an 80 mesh screen. Then, water was added until the amount of solids was 40% by weight.

### Example 1

Compositions for forming a toner receiving layer and an outermost layer, having the following compositions, were prepared:

[Composition for forming a toner receiving layer]

| | |
|---|---|
| Calcium carbonate (OMAYA, Hydrocarb 60 ME) | 78% by weight |
| Polyvinyl alcohol (KURARAY, PVA 105) | 1% by weight |
| Acrylic latex (Hansol Chemical, SAV 4720) | 6% by weight |
| Sodium chloride (Junsei) | 3% by weight |
| Polyethylene glycol (Junsei) | 4% by weight |
| Water | 400% by weight |

[Composition for forming an outermost layer]

| | |
|---|---|
| Thermoplastic resin incorporated with | 92% by weight |
| UV absorbing component (Preparation Example 1) | |
| Polyvinyl alcohol (KURARAY, PVA 105) | 8% by weight |
| Sodium chloride (Junsei) | 3% by weight |
| Polyethylene glycol (Junsei) | 4% by weight |
| Water | 400% by weight |

The resulting compositions for forming a toner receiving layer and an outermost layer were coated on a base paper of 110 g/m² using a bar coater, and then dried at a temperature of 110° C. for 3 minutes, thereby preparing a recording medium for an electrophotographic image forming apparatus with a toner receiving layer having a thickness of about 10 μm and an outermost layer having a thickness of about 11 μm.

### Example 2

Compositions for forming a toner receiving layer and an outermost layer, having the following compositions, were prepared:

[Composition for forming a toner receiving layer]

| | |
|---|---|
| Calcium carbonate (OMAYA, Hydrocarb 60 ME) | 82% by weight |
| Polyvinyl alcohol (KURARAY, PVA 105) | 1% by weight |
| Acrylic latex (Hansol Chemical, SAV 4720) | 5% by weight |
| Sodium chloride (Junsei) | 2% by weight |
| Polyethylene glycol (Junsei) | 4% by weight |
| Water | 400% by weight |

[Composition for forming an outermost layer]

| | |
|---|---|
| Thermoplastic resin incorporated with | 95% by weight |
| UV absorbing component (Preparation Example 2) | |
| Polyvinyl alcohol (KURARAY, PVA 105) | 5% by weight |
| Sodium chloride (Junsei) | 3% by weight |
| Polyethylene glycol (Junsei) | 4% by weight |
| Water | 400% by weight |

The resulting compositions for forming a toner receiving layer and an outermost layer were coated on a base paper of 110 g/m² using a bar coater, and then dried at a temperature of 110° C. for 3 minutes, thereby preparing a recording medium for an electrophotographic image forming apparatus with a toner receiving layer having a thickness of about 10 μm and an outermost layer having a thickness of about 11 μm.

### Comparative Example 1

A recording medium for an electrophotographic image forming apparatus was prepared in the same manner as in Example 1, except that an outermost layer was not formed.

### Comparative Example 2

A recording medium for electrophotographic image forming apparatus was prepared in the same manner as in Example 1, except that the composition of the outermost layer was as follows:

[Composition for forming an outermost layer]

| | |
|---|---|
| Plastic pigment (Dow, DPP 3720) | 10% by weight |
| Polyvinyl alcohol (KURARAY, PVA 105) | 90% by weight |
| Acrylic latex (Hansol Chemical, SAV 4720) | 6% by weight |
| Sodium chloride (Junsei) | 3% by weight |
| Polyethylene glycol (Junsei) | 4% by weight |
| Water | 400% by weight |

### Comparative Example 3

A recording medium for an electrophotographic image forming apparatus was prepared in which a UV absorbing agent was included in an outermost layer and compositions for forming a toner receiving layer and an outermost layer were as follows:

[Composition for forming a toner receiving layer]

| | |
|---|---|
| Calcium carbonate (OMAYA, Hydrocarb 60 ME) | 82% by weight |
| Polyvinyl alcohol (KURARAY, PVA 105) | 1% by weight |
| Acrylic latex (Hansol Chemical, SAV 4720) | 5% by weight |
| Sodium chloride (Junsei) | 2% by weight |
| Polyethylene glycol (Junsei) | 4% by weight |
| Water | 400% by weight |

[Composition for forming an outermost layer]

| | |
|---|---|
| Plastic pigment (Dow, DPP 3720) | 90% by weight |
| Polyvinyl alcohol (KURARAY, PVA 105) | 10% by weight |
| Acrylic latex (Hansol Chemical, SAV 4720) | 6% by weight |
| Sodium chloride (Junsei) | 3% by weight |
| Polyethylene glycol (Junsei) | 4% by weight |
| Water | 400% by weight |
| UV absorbing agent | 1.0% by weight |
| (EVERGREEN, 2-[2′-hydroxy-3′-methyl-5′- | |
| methylphenyl]benzotriazole) | |

Image printing was performed on the recording mediums of Examples 1 and 2 and Comparative Examples 1-3 using a color laser beam printer (Samsung Electronics, CLP-300).

The printed recording mediums of Examples 1 and 2 and Comparative Examples 1-3 were evaluated for gloss, light resistance and discoloration resistance. Evaluation methods used to measure these properties are described as follows.

Evaluation Methods

(1) Light Resistance

A light resistance tester (Q-SUN 3000; Xenon lamp) was used for this evaluation and light was irradiated at 1.1 W/m² at 420 nm and at a black panel temperature of 63° C. for 10 hours. Yellow, magenta, cyan and black beta images were printed using the same printer as described above and L*, a* and b* were determined. ΔE was calculated from a difference between values before and after test and was evaluated according to the following criterion:

⊚: ΔE less than 3,

◯: ΔE 3 or more and less than 7,

Δ: ΔE 7 or more and less than 10,

×: ΔE 10 or more.

(2) Discoloration Resistance

A gas corrosion tester (TG100-ISO, SUGA) was used for this evaluation and the printed recording mediums were left in a mixed gas (O₃, SO₂, NO₂) for 2 hours. Yellow, magenta, cyan and black beta images were printed using the same printer as described above and L*, a* and b* were determined. ΔE was calculated from a difference between values before and after test and was evaluated according to the following criterion:

⊚: ΔE less than 3,

◯: ΔE 3 or more and less than 7,

Δ: ΔE 7 or more and less than 10,

×: ΔE 10 or more.

(3) Gloss

A gloss tester (BYK micro-TRI-gloss) was used for this evaluation and gloss was obtained at 85 degrees. The higher the value of gloss, the better the gloss.

TABLE 1

| | | | Comparative | Comparative | Comparative |
|---|---|---|---|---|---|
| | Example 1 | Example 2 | Example 1 | Example 2 | Example 3 |
| Light | ⊚ | ⊚ | X | X | ◯ |
| resistance | | | | | |
| Discoloration | ◯ | ◯ | X | X | ◯ |
| resistance | | | | | |
| Gloss | 85° | 78° | 3.4° | 70° | 72° |

⊚: Very good,
◯: Good,
Δ: Poor,
X: Very poor

It can be seen from the results of Table 1 that the recording mediums of Examples 1 and 2 include the thermoplastic resin incorporated with a UV absorbing unit in an outermost layer, thereby having good light resistance, discoloration resistance and gloss.

The recording medium of Comparative Example 1 having no outermost layer has poor light resistance, discoloration resistance and gloss. The recording medium of Comparative Example 2 having the outermost layer, in which the thermoplastic resin is not incorporated with a UV absorbing unit, has good gloss, but poor light resistance and discoloration resistance. The recording medium of Comparative Example 3 having the outermost layer, in which the UV absorbing unit is included, but is not incorporated with the thermoplastic resin, has good gloss and light resistance, but has poor smoothness, a bubble trace or a rough surface, and poor compatibility with an aqueous composition.

As described above, the recording medium for an electrophotographic image forming apparatus according to the present invention includes a thermoplastic resin incorporated with a UV absorbing unit in an outermost layer, thereby having good gloss, light resistance and discoloration resistance.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A recording medium for an electrophotographic image forming apparatus, comprising:
a substrate layer,
a toner receiving layer formed on one side or both sides of the substrate layer and an outermost layer formed on the toner receiving layer,
wherein the outermost layer comprises a thermoplastic resin incorporating a UV absorbing component.

2. The recording medium for an electrophotographic image forming apparatus of claim 1, wherein the thermoplastic resin incorporating a UV absorbing component comprises about 5 to 60 mol % of a repeating unit of a copolymerizable radical polymerizable monomer and about 40 to 95 mol % of a repeating unit of a UV absorbing monomer and where the thermoplastic resin has a weight average molecular weight of about 500 to 50,000.

3. The recording medium for an electrophotographic image forming apparatus of claim 2, wherein the UV absorbing monomer is at least one selected from the group consisting of a benzophenone-based UV absorbing monomer represented by Formula 1, a benzotriazole-based UV absorbing monomer represented by Formula 2, and a formamidine-based UV absorbing monomer represented by Formula 3: 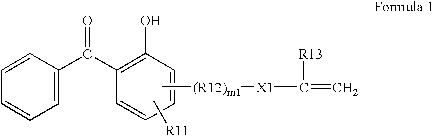
in which R11 is a hydrogen atom, a substituted or unsubstituted C₁-C₆ alkyl group, or a substituted or unsubstituted C₁-C₆ alkoxyl group,
R12 is a substituted or unsubstituted C₁-C₁₀ alkylene group or a substituted or unsubstituted C₁-C₁₀ oxyalkylene group,
m1 is0 or 1,
R13 is a hydrogen atom or a substituted or unsubstituted C₁-C₆ alkyl group and
X1 is an ester group, an amide group, an ether group, or a urethane group, 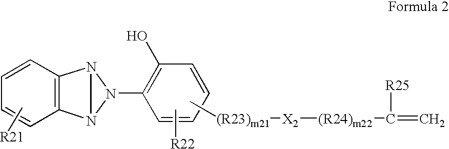
in which R21 is a hydrogen atom, a halogen atom, or a C₁-C₆ alkyl group,
R22 is a hydrogen atom, a substituted or unsubstituted C₁-C₆ alkyl group, or a substituted or unsubstituted C₁-C₆ alkoxyl group,
R23 is a substituted or unsubstituted C₁-C₁₀ alkylene group or a substituted or unsubstituted C₁-C₁₀ oxyalkylene group,
m21 is0 or 1,
R24 is a substituted or unsubstituted C₁-C₈ alkylene group,
m22 is 0 or 1,
R25 is a hydrogen atom, or a substituted or unsubstituted C₁-C₆ alkyl group, and
X2 is an ester group, an amide group, an ether group, or a urethane group, and 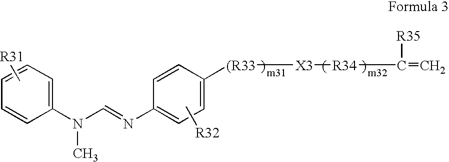
in which R31 is a hydrogen atom, a halogen atom, or a C₁-C₆ alkyl group,
R32 is a hydrogen atom, a substituted or unsubstituted C₁-C₆ alkyl group, or a substituted or unsubstituted C₁-C₆ alkoxyl group,
R33 is a substituted or unsubstituted C₁-C₁₀ alkylene group or a substituted or unsubstituted C₁-C₁₀ oxyalkylene group,
m31 is0 or 1,
R34 is a substituted or unsubstituted C₁-C₈ alkylene group,
m32 is 0 or 1,
R35 is a hydrogen atom, or a substituted or unsubstituted C₁-C₆ alkyl group, and
X3 is an ester group, an amide group, an ether group, or a urethane group.

4. The recording medium for an electrophotographic image forming apparatus of claim 2, wherein the polymerizable monomer is at least one selected from the group consisting of an unsaturated aromatic compound, an alkyl ester of α,β-unsaturated monocarboxylic acid, an amide group-containing monomer, an unsaturated carboxylic acid and a hydroxyl group-containing monomer.

5. The recording medium for an electrophotographic image forming apparatus of claim 1, wherein the thermoplastic resin are particles having a multi-layered structure having a core part and a shell part.

6. The recording medium for an electrophotographic image forming apparatus of claim 1, wherein the amount of the thermoplastic resin is about 75 to 95 parts by weight based on 100 parts by weight of total solids of the outermost layer.

7. The recording medium for an electrophotographic image forming apparatus of claim 1, wherein the outermost layer further comprises a binder.

8. The recording medium for an electrophotographic image forming apparatus of claim 7, wherein the binder of the outermost layer is at least one selected from the group consisting of polyvinyl alcohol, polyvinyl pyrrolidone, methyl cellulose, hydroxy propylmethyl cellulose, gelatin, polyethylene oxide, acrylic polymer, polyester, polyurethane, epoxy resin, latex, and quaternary ammonium-based copolymer.

9. The recording medium for an electrophotographic image forming apparatus of claim 1, wherein the outermost layer further comprises additives.

10. The recording medium for an electrophotographic image forming apparatus of claim 1, wherein the outermost layer has a thickness of about 5 to 15 μm.

11. The recording medium for an electrophotographic image forming apparatus of claim 1, wherein the substrate layer is one or a laminate of two or more layers selected from the group consisting of a synthetic paper, a uncoated paper, an art paper, a coated paper, a mixed drafting paper, baryta, an incorporated paper, cardboard, cellulose fiber paper, a transparent or translucent plastic film selected from polyolefin, polyvinyl chloride, polyethylene terephthalate, polystyrene, polymethacrylate or polycarbonate, and a foam sheet.

12. The recording medium for an electrophotographic image forming apparatus of claim 1, wherein the substrate layer has a thickness of about 25 to 260 μm.

13. The recording medium for an electrophotographic image forming apparatus of claim 1, wherein the toner receiving layer further comprises a filler and a binder.

14. The recording medium for an electrophotographic image forming apparatus of claim 13, wherein the filler is an inorganic filler selected from the group consisting of kaolin clay, silica, calcium carbonate, talc, aluminum hydroxide, satin white, titanium dioxide, calcined clay, zinc oxide, and barium sulfate, or an organic filler selected from the group consisting of styrene-based resin, acrylic resin, vinyl chloride, and polycarbonate.

15. The recording medium for an electrophotographic image forming apparatus of claim 13, wherein the binder of the toner receiving layer is at least one selected from the group consisting of polyvinyl alcohol, polyvinyl pyrrolidone, methyl cellulose, hydroxy propylmethyl cellulose, gelatin, polyethylene oxide, acrylic polymer, polyester, polyurethane, epoxy resin, latex, and quaternary ammonium-based copolymer.

16. The recording medium for an electrophotographic image forming apparatus of claim 1, wherein the toner receiving layer has a thickness of about 1 to 20 μm.

17. The recording medium for an electrophotographic image forming apparatus of claim 1, wherein the toner receiving layer further comprises additives.

18. A composition for forming an outermost layer of a recording medium for an electrophotographic image forming apparatus, comprising:
a thermoplastic resin incorporating a UV absorbing group, which contains about 5 to 60 mol % of a repeating unit of a copolymerizable radical polymerizable monomer and about 40 to 95 mol % of a repeating unit of a UV absorbing monomer, and has a weight average molecular weight of about 500 to 50,000, and a solvent.

19. The composition for forming an outermost layer of a recording medium for an electrophotographic image forming apparatus of claim 18, wherein the UV absorbing monomer is at least one selected from the group consisting of a benzophenone-based UV absorbing monomer represented by Formula 1, a benzotriazole-based UV absorbing monomer represented by Formula 2, and a formamidine-based UV absorbing monomer represented by Formula 3: 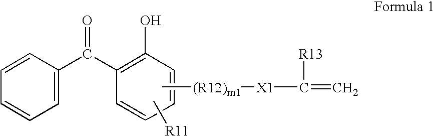
in which R11 is a hydrogen atom, a substituted or unsubstituted C₁-C₆ alkyl group, or a substituted or unsubstituted C₁-C₆ alkoxyl group,
R12 is a substituted or unsubstituted C₁-C₁₀ alkylene group or a substituted or unsubstituted C₁-C₁₀ oxyalkylene group,
m1 is 0 or 1,
R13 is a hydrogen atom or a substituted or unsubstituted C₁-C₆ alkyl group and
X1 is an ester group, an amide group, an ether group, or a urethane group, 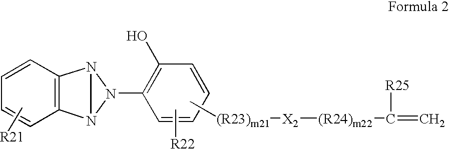
in which R21 is a hydrogen atom, a halogen atom, or a C₁-C₆ alkyl group,
R22 is a hydrogen atom, a substituted or unsubstituted C₁-C₆ alkyl group, or a substituted or unsubstituted C₁-C₆ alkoxyl group,
R23 is a substituted or unsubstituted C₁-C₁₀ alkylene group or a substituted or unsubstituted C₁-C₁₀ oxyalkylene group,
m21 is 0 or 1,
R24 is a substituted or unsubstituted C₁-C₈ alkylene group,
m22 is 0 or 1,
R25 is a hydrogen atom, or a substituted or unsubstituted C₁-C₆ alkyl group, and
X2 is an ester group, an amide group, an ether group, or a urethane group, and 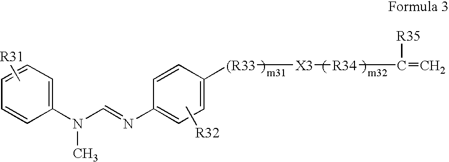
in which R31 is a hydrogen atom, a halogen atom, or a C₁-C₆ alkyl group,
R32 is a hydrogen atom, a substituted or unsubstituted C₁-C₆ alkyl group, or a substituted or unsubstituted C₁-C₆ alkoxyl group,
R33 is a substituted or unsubstituted C₁-C₁₀ alkylene group or a substituted or unsubstituted C₁-C₁₀ oxyalkylene group,
m31 is 0 or 1,
R34 is a substituted or unsubstituted C₁-C₈ alkylene group,
m32 is0 or 1,
R35 is a hydrogen atom, or a substituted or unsubstituted C₁-C₆ alkyl group, and
X3 is an ester group, an amide group, an ether group, or a urethane group.

20. The composition for forming an outermost layer of a recording medium for an electrophotographic image forming apparatus of claim 18, wherein the polymerizable monomer is at least one selected from the group consisting of an unsaturated aromatic compound, an alkyl ester of α,β-unsaturated monocarboxylic acid, an amide group-containing monomer, and an unsaturated carboxylic acid.
